(19) United States
(12) Patent Application Publication
(10) Pub. No.: US 2026/0105428 A1
(43) Pub. Date: Apr. 16, 2026

(54) DIRECT ELECTRONIC BILL PAYMENT WITH REAL-TIME FUNDS AVAILABILITY

(71) Applicant: Early Warning Services, LLC, Scottsdale, AZ (US)

(72) Inventors: Rohit Mehtani, San Francisco, CA (US); Suresh Munusamy, Scottsdale, AZ (US); Rajesh Kulkarni, Scottsdale, AZ (US); Charles Schaefer, Kentfield, CA (US); Bruce Rapport, Folsom, CA (US); Rich Rezek, Zionsville, IN (US); James Armistead, Mill Creak, CA (US)

(73) Assignee: Early Warning Services, LLC, Scottsdale, AZ (US)

(21) Appl. No.: 19/419,459

(22) Filed: Dec. 15, 2025

Related U.S. Application Data
(63) Continuation of application No. 17/900,092, filed on Aug. 31, 2022, now Pat. No. 12,499,427.
(60) Provisional application No. 63/239,107, filed on Aug. 31, 2021.

(51) Int. Cl. G06Q 20/10; G06Q 20/02; G06Q 20/40

(52) U.S. Cl. CPC G06Q 20/102; G06Q 20/023; G06Q 20/4097

(57) ABSTRACT

A method including receiving, at a payment-messaging computing system from a biller financial institution, a request for information about a public consumer token of a consumer. The method also includes determining that the public consumer token of the consumer is registered and active in a directory of the payment-messaging computing system. The method additional includes determining a risk metric representing a risk of using the public consumer token for the bill payment. The method further includes sending the risk metric from the payment-messaging computing system to the biller financial institution to cause the biller financial institution to send the risk metric to the biller computer to allow the biller to determine whether to assume liability for the bill payment or instead request the consumer financial institution assume liability and whether to perform a step-up authentication, based on the risk metric. The method additionally includes receiving, at the payment-messaging computing system from the biller financial institution, an authorization message for the bill payment after the authorization message was provided to the biller financial institution by the biller computer. The method further includes sending the authorization message for the bill payment to the consumer financial institution, to cause the consumer financial institution to send a real-time payment message through the payment-messaging computing system to the biller financial institution to make funds available in real-time in the biller account for the bill payment. Other embodiments are described.

### CROSS-REFERENCE TO RELATED APPLICATION

This application is a continuation of U.S. patent application Ser. No. 17/900,092, filed Aug. 31, 2022, which claims the benefit of U.S. Provisional Application No. 63/239,107, filed Aug. 31, 2021. U.S. patent application Ser. No. 17/900,092 and U.S. Provisional Application No. 63/239,107 are incorporated herein by reference in their entirety.

### TECHNICAL FIELD

This disclosure relates generally to transaction processing, and relates more particularly to direct electronic bill payment with real-time funds availability.

### BACKGROUND

In conventional payment methods, after a biller sends a bill to a customer, the customer can initiate a payment to the biller through various different methods, such as through the customer's financial institution, a consolidated bill-pay provider, or the biller's financial institution, for example. These conventional methods, however, generally do not allow the biller to receive payment funds in real-time after the customer has initiated the payment to the biller, and generally involve the customer providing the biller with personal information, such as an account number, which can create security vulnerabilities.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for direct electronic bill payment with real-time funds availability, according to an embodiment.

FIG. 4 illustrates an exemplary display screen of a mobile device to allow the consumer of FIG. 3 to make a direct bill payment to the biller of FIG. 3 using a public identifier;

FIG. 5 illustrates an exemplary display screen of a computer to allow the consumer of FIG. 3 to make a direct bill payment to the biller of FIG. 3 using a public identifier;

FIG. 6 illustrates a flow chart for a method of facilitating direct electronic bill payment with real-time funds availability in a biller liability model, according to an embodiment;

FIG. 7 illustrates a flow chart for a method of facilitating direct electronic bill payment with real-time funds availability in a bank authentication model, according to an embodiment; and

FIG. 8 illustrates a flow chart for a method of facilitating direct electronic bill payment with real-time funds availability, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 1 second, 5 seconds, 10 seconds, 30 seconds, 1 minute, 2 minutes, 5 minutes, 10 minutes, or 15 minutes.

### Description of Examples of Embodiments

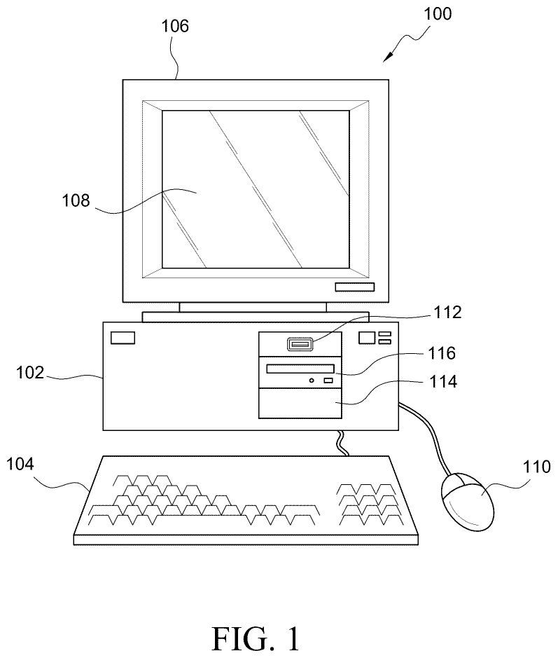

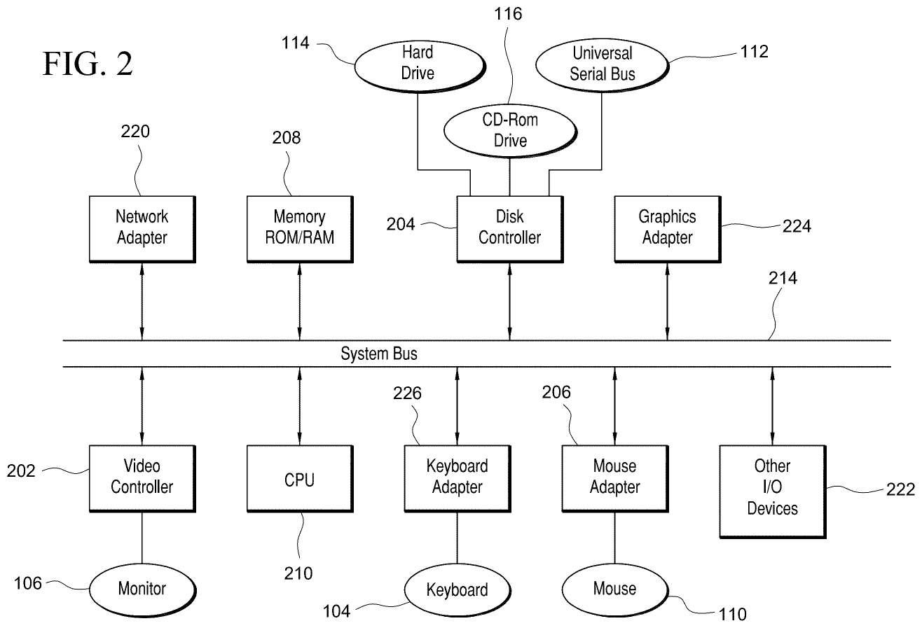

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, or (v) the Windows Mobile™ operating system by Microsoft Corp. of Redmond, Washington, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general-purpose computer to a special purpose computer. For purposes of illustration, programs and other executable program components are shown herein as discrete systems, although it is understood that such programs and components may reside at various times in different storage components of computing system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

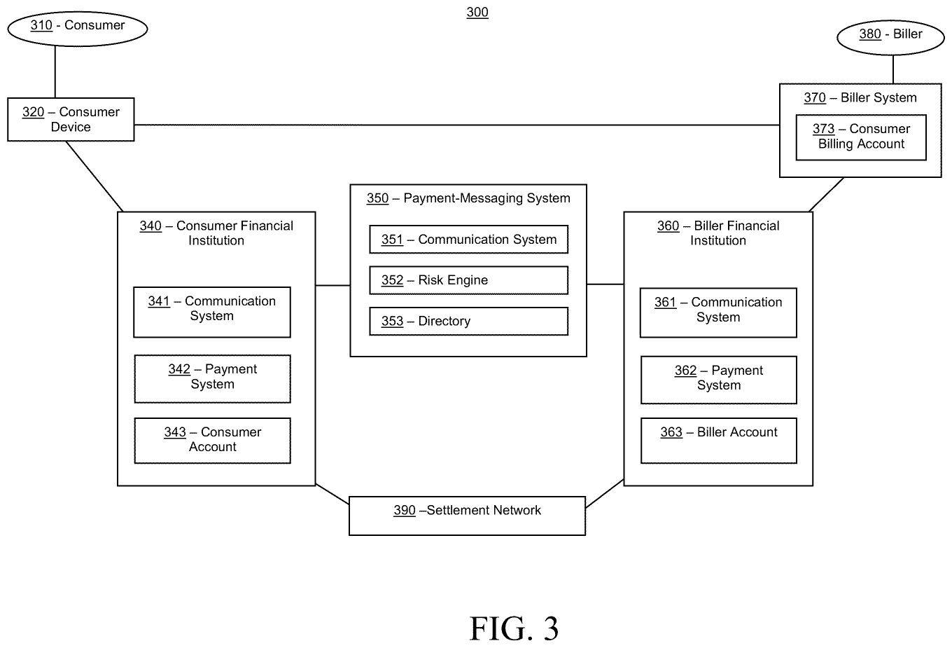

Turning ahead in the drawings, FIG. 3 illustrates a block diagram of a system 300 that can be employed for direct electronic bill payment with real-time funds availability, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include a consumer 310, a consumer device 320, a consumer financial institution 340, a payment-messaging system 350, a biller financial institution 360, a biller system 370, a biller 380, and/or a settlement network 390. Consumer device 320, consumer financial institution 340, payment-messaging system 350, biller financial institution 360, biller system 370, and/or a settlement network 390 can each be or include a computer system, such as computer system 100 (FIG. 1), as described above, and can each be a single computer, a single server, or a cluster or collection of computers or servers, or a cloud of computers or servers. In some embodiments, various systems of system 300 (e.g., consumer device 320, consumer financial institution 340, payment-messaging system 350, biller financial institution 360, biller system 370, and/or a settlement network 390) can be in data communication with one or more of the other systems of system 300 through one or more networks, such as the Internet or other suitable networks (not shown).

In a number of embodiments, consumer device 320 can be used by consumer 310, which can be a person or entity that can make a direct bill payment to biller 380 using system 300. In many embodiments, consumer 310 can have a consumer account 343 maintained at a consumer financial institution 340. Consumer account 343 can be an account used to fund the payment, such as a demand deposit account of consumer 310 maintained at consumer financial institution 340. In a number of embodiments, consumer 310 can access consumer financial institution 340 through consumer device 320, such as through a web portal, web application, or mobile wallet provided by consumer financial institution 340. In a number of embodiments, consumer device 320 can communicate with a communication system 341 at consumer financial institution 340, such as a digital banking system provided by consumer financial institution 340.

In several embodiments, biller system 370 can be used by biller 380, which can be a person or entity that can receive a bill payment from consumer 310 using system 300. In some embodiments, biller system 370 can be a system provided by a billing service provider (BSP), which can be a third-party service provider used by biller 380 to handle bill processing. In many embodiments, biller 380 can have a biller account 363 maintained at a biller financial institution 360. Biller account 363 can be an account used to receive the payment, such as a demand deposit account of biller 380 at biller financial institution 360. In a number of embodiments, biller 380 can access biller financial institution 360 through biller system 370, such as through a web portal, web application, or mobile application provided by biller financial institution 360. In some embodiments, consumer 310 can be a customer or consumer of biller 380, and biller 380 can be a biller, such as a merchant, a utility company, a bank, a school, a government, a service provider, or another suitable provider of goods and/or services to consumer 310. In several embodiments, biller system 370 can include a billing system to track accounts of customers (e.g., consumer 310). In a number of embodiments, consumer 310 can have a consumer billing account 373 at biller system 370 that tracks how much consumer 310 owes biller 380. For example, the billing account can track how much consumer 310 owes biller 380 for a credit card, an auto loan, a mortgage, a utility service, etc. Biller 380 generally sends bills (e.g., invoices) to request payment from customers, such as consumer 310, and these bills can be sent periodically or on a one-time basis. In a number of embodiments, biller system 370 can communicate with a communication system 361 at biller financial institution 360, such as a corporate portal provided by biller financial institution 360.

In many embodiments, payment-messaging system 350 can be in data communication with various financial institutions, such as consumer financial institution 340 and biller financial institution 360. In some embodiments, payment-messaging system 350 can be a payment-messaging network provided by an entity separate from consumer financial institution 340 and biller financial institution 360, such as the Zelle® network provided Early Warning Services, LLC, of Scottsdale, Arizona, or another suitable entity.

In several embodiments, settlement network 390 can be in data communication with various financial institutions, such as consumer financial institution 340 and biller financial institution 360, and in some embodiments, can be in data communication with payment-messaging system 350. In some embodiments, settlement network 390 can be a settlement network provided by an entity separate from consumer financial institution 340 and biller financial institution 360, such as ACH (Automated Clearing House), or another suitable settlement network. In many embodiments, settlement network 390 can communicate with payment hubs at financial institutions, such as a payment system 342 at consumer financial institution 340 and a payment system 362 at biller financial institution 360.

In certain embodiments, consumer device 320 and/or biller system 370 can be desktop computers, laptop computers, mobile devices, computer servers, and/or other endpoint devices. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

In many embodiments, payment-messaging system 350 and/or the systems of consumer financial institution 340 and biller financial institution 360 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to payment-messaging system 350 and/or the systems of consumer financial institution 340 and biller financial institution 360 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of payment-messaging system 350 and/or the systems of consumer financial institution 340 and biller financial institution 360. In a similar manner, the processors and/or the non-transitory computer-readable media can be local and/or remote to each other.

Meanwhile, in many embodiments, payment-messaging system 350 and/or the systems of consumer financial institution 340 and biller financial institution 360 also can be configured to communicate with one or more databases. For example, payment-messaging system 350 can include a database system, such as directory 353. Directory 353 can include profile information about users that have registered to facilitate payments using payment-messaging system 350. For example, once consumer 310 registers with payment-messaging system 350, such as through consumer financial institution 340, consumer financial institution 340 can provide a payment profile identification data structure to payment-messaging system 350, which can include one or more public identifiers of consumer 310, such as an email address, phone number, or other suitable public identifier of consumer 310, and can include a tokenized identifier (e.g., a Zelle tag provided by the Zelle network) that can represent consumer account 343 without including the account number of consumer account 343. In many embodiments, the tokenized identifier was provided to payment-messaging system 350 by consumer financial institution 340 when consumer 310 registered to use payment-messaging system 350. In many embodiments, consumer financial institution 340 can maintain a mapping from the tokenized identifier to account information for consumer account 343. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, payment-messaging system 350, the systems of consumer financial institution 340 and biller financial institution 360, and/or one or more of the databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc. ; exemplary LAN and/or WAN protocol(s) can include Institute of Electrical and Electronic Engineers (IEEE) 802.3 (also known as Ethernet), IEEE 802.11 (also known as WiFi), etc. ; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, payment-messaging system 350 can include a communication system 351, a risk engine 352, and/or a directory 353. In many embodiments, the systems of payment-messaging system 350 can be modules of computing instructions (e.g., software modules) stored at non-transitory computer readable media that operate on one or more processors. In other embodiments, the systems of payment-messaging system 350 can be implemented in hardware. Payment-messaging system 350 can be a computer system, such as computer system 100 (FIG. 1), as described above, and can be a single computer, a single server, or a cluster or collection of computers or servers, or a cloud of computers or servers. Additional details regarding payment-messaging system 350 and the components thereof are described herein.

In several embodiments, consumer 310 can use consumer device 320 to access a bill payment portal (e.g., a website) provided by biller system 370 to make a payment to biller 380. In conventional bill payment portals, consumer 310 can make a payment to biller 380 by providing account information, such as a checking account number, a credit card number, a debit card number, or other payment account information. This personal information can be sensitive information that poses a security risk, such as being used by bad actors to make unauthorized charges to consumer account 343 and/or other security risks. Many biller systems (e.g., 370) store such sensitive data of consumers (e.g., 310), which poses security risks of bad actors obtaining unauthorized access to this sensitive data. Billers (e.g., 380) often maintain costly compliance programs, and are liable for returns and processing fees incurred using these conventional payment options. In many embodiments, system 300 can advantageously enable consumer 310 to make direct bill payments to biller 380 by providing a public identifier (e.g., email address, phone number, etc.) of consumer 310 to biller 380, without providing personal information, such as bank account numbers, credit card numbers, etc.

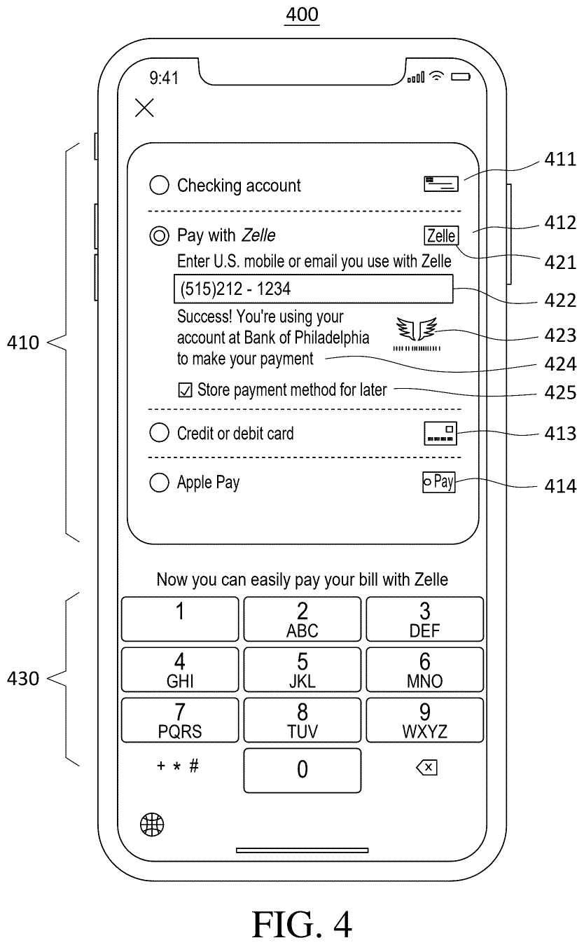

Turning ahead in the drawings, FIG. 4 illustrates an exemplary display screen 400 of a mobile device to allow consumer 310 (FIG. 3) to make a direct bill payment to biller 380 (FIG. 3) using a public identifier (e.g., email address, phone number, etc.). Display screen 400 is merely exemplary, and embodiments of the display screen are not limited to the embodiments presented herein. The display screen can be employed in many different embodiments or examples not specifically depicted or described herein, and can include other suitable elements. In many embodiments, biller system 370 (FIG. 3) can provide an interface for display on consumer device 320 (FIG. 3) (e.g., as a mobile device), which can include display screen 400. In a number of embodiments, the interface can allow consumer 310 (FIG. 3) to initiate the direct payment to biller 380 (FIG. 3) and provide the public identifier (e.g., email address, phone number, etc.).

In many embodiments, display screen 400 can include payment method options 410, one of which can be selected by consumer 310 (FIG. 3) to make the payment. Some of these payment methods can be conventional, such as using an option 411 to use a checking account, an option 413 to use a credit or debit card, or an option 414 to use Apple Pay. In several embodiments, display screen 400 additionally, or alternatively, can include, among payment method options 410, an option 412 of using payment-messaging system 350 (FIG. 3). In some embodiments, payment-message system 350 can be Zelle, which can be represented by a logo 421. In many embodiments, display screen 400 can allow consumer 310 (FIG. 3) of payment-messaging system 350 to enter a public identifier (e.g., email, phone number, etc.) in a public identifier input field 422, such as by using a virtual keypad 430. The public identifier can be used to make the payment. In some embodiments, the public identifier was already used by consumer 310 (FIG. 3) to sign up for payment-messaging system 350 (FIG. 3) using the public identifier. For example, as shown in FIG. 4, consumer 310 (FIG. 3) can enter the phone number of consumer 310 (FIG. 3) in public identifier input field 422, which has already been registered with payment-messaging system 350 (FIG. 3). In many embodiments, display screen 400 can display an informational message 424 to inform consumer 310 (FIG. 3) of which financial institution (e.g., 340 (FIG. 3)) will be used for the payment through payment-messaging system 350 (FIG. 3), and/or a logo 423 for that financial institution can be displayed. In a number of embodiments, display screen 400 also can provide a selector 425 to allow consumer 310 (FIG. 3) to indicate whether or not the option 412 of using payment-messaging system 350 (FIG. 3), along with the public identifier entered in public identifier input field 422 should be stored, to allow that payment method to be readily used in future transactions.

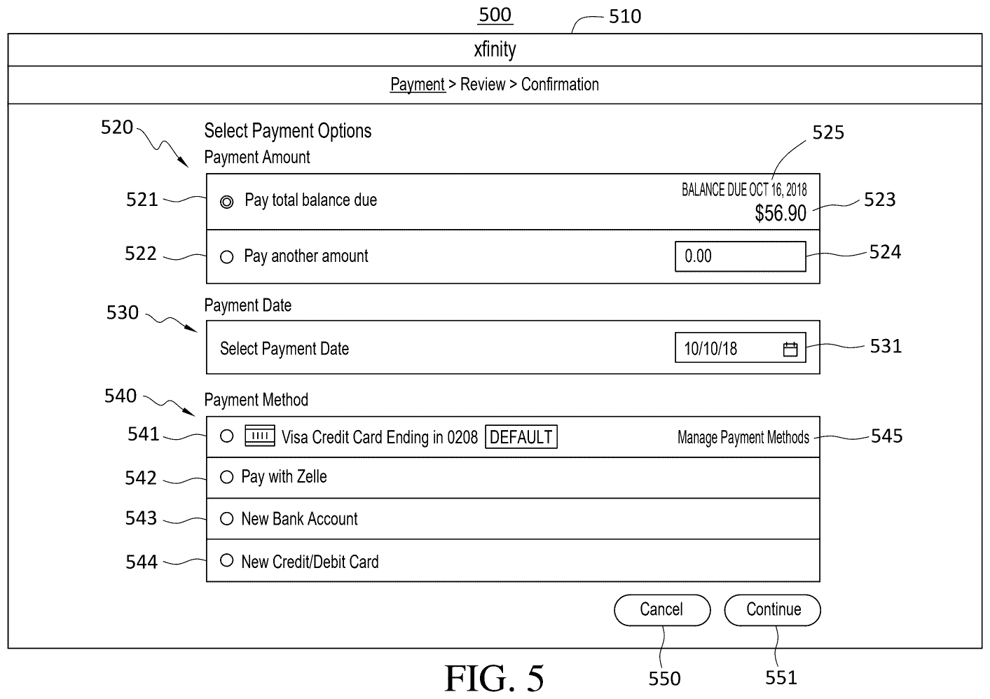

Turning ahead in the drawings, FIG. 5 illustrates an exemplary display screen 500 of a computer (e.g., laptop, desktop, etc.) to allow consumer 310 (FIG. 3) to make a direct bill payment to biller 380 (FIG. 3) using a public identifier (e.g., email address, phone number, etc.). Display screen 500 is merely exemplary, and embodiments of the display screen are not limited to the embodiments presented herein. The display screen can be employed in many different embodiments or examples not specifically depicted or described herein, and can include other suitable elements. Display screen 500 can be similar to display screen 400 (FIG. 4). In many embodiments, the interface provided by biller system 370 (FIG. 3) can be displayed on consumer device 320 (FIG. 3) (e.g., as a laptop, desktop, etc.), which can include display screen 500. In a number of embodiments, the interface can allow consumer 310 (FIG. 3) to initiate the direct payment to biller 380 (FIG. 3) and provide the public identifier (e.g., email address, phone number, etc.).

In a number of embodiments, display screen 500 can be used to initiate the direct payment to a biller (e.g., Xfinity), and the name and/or logo of the biller can be shown on a title bar 510 of display screen 500. In many embodiments, display screen can allow consumer 310 (FIG. 3) to select payment options, such as payment amount, payment date, payment method, and/or other suitable options. For example, display screen can allow consumer 310 (FIG. 3) to select the payment amount in payment amount options 520. Payment amount options 520 can allow consumer 310 (FIG. 3) to select a pay total balance due option 521 to pay the total balance due in consumer billing account 373 (FIG. 3). The total amount due can be shown in total amount due display field 523, and the due date can be displayed in due date display field 525. Instead, consumer 310 (FIG. 3) can select a pay another amount option 522 to enter another amount in payment amount input field 524. In some embodiments, display screen 500 can allow consumer 310 (FIG. 3) to select a payment date in payment date option 530. For example, the date can be input in payment date input field 531, which can be used by consumer 310 (FIG. 3) to enter the current date or a specific date in the future. In many embodiments, display screen 500 can include payment method options 540, which can be similar or identical to payment method options 410 (FIG. 4) shown on display screen 400 (FIG. 4). In some embodiments, payment method options 540 can be conventional, such as an option 541 to use a credit card or debit card that has already been setup, an option 543 to use a bank account that has not yet been setup, and/or an option 544 to use a credit card or debit card that has not yet been setup. In several embodiments, display screen 500 additionally, or alternatively, can include, among payment method options 410, an option 542 of using payment-messaging system 350 (FIG. 3), which can allow consumer 310 (FIG. 3) of payment-messaging system 350 to enter a public identifier to make the payment, such as based on consumer 310 (FIG. 3) having already registered the public identifier in payment-messaging system 350 (FIG. 3). In many embodiments, a button/link 545 can allow consumer 310 (FIG. 3) to manage payment options that have already been setup.

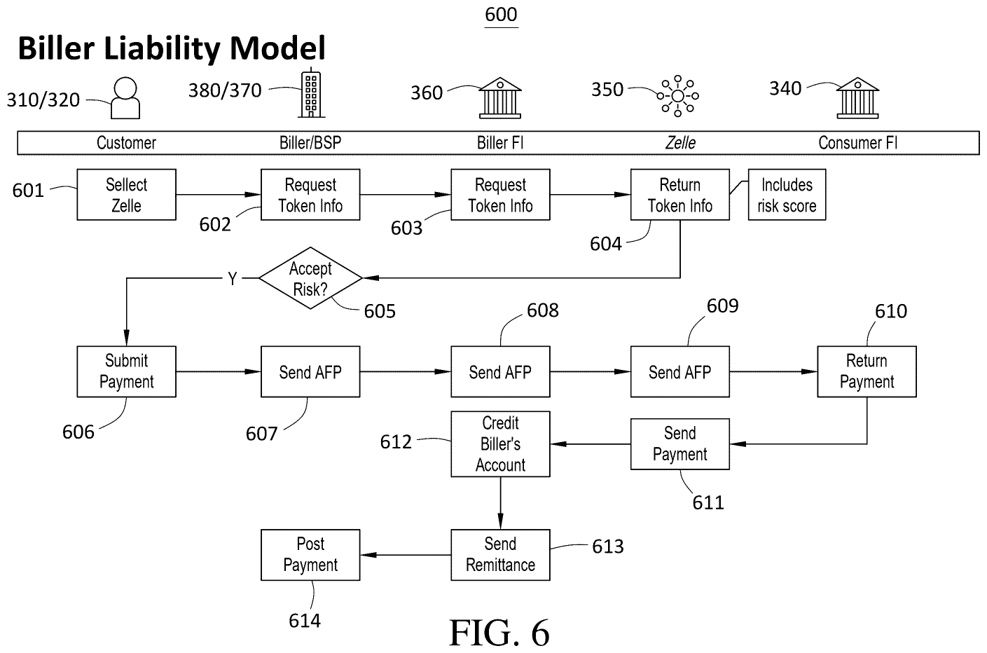

Turning ahead in the drawings, FIG. 6 illustrates a flow chart for a method 600 of facilitating direct electronic bill payment with real-time funds availability in a biller liability model, according to an embodiment. Method 600 is merely exemplary and is not limited to the embodiments presented herein. Method 600 can be employed in many different embodiments or examples not specifically depicted or described herein. In some embodiments, the procedures, the processes, and/or the activities of method 600 can be performed in the order presented. In other embodiments, the procedures, the processes, and/or the activities of method 600 can be performed in any suitable order. In still other embodiments, one or more of the procedures, the processes, and/or the activities of method 600 can be combined or skipped.

In many embodiments, system 300 (FIG. 3) can be suitable to perform method 600 and/or one or more of the activities of method 600, such as activities 601-614. In these or other embodiments, one or more of the activities of method 600 can be implemented as one or more computing instructions configured to run at one or more processors and configured to be stored at one or more non-transitory computer readable media. Such non-transitory computer readable media can be part of system 300. The processor(s) can be similar or identical to the processor(s) described above with respect to computer system 100 (FIG. 1). In some embodiments, method 600 and other activities in method 600 can include using a distributed network including distributed memory architecture to perform the associated activity. This distributed architecture can reduce the impact on the network and system resources to reduce congestion in bottlenecks while still allowing data to be accessible from a central location.

Referring to FIG. 6, method 600 can begin with an activity 601 of consumer 310 using consumer device 320 (together consumer 310 and consumer device 320 are referred to in FIG. 6 as “customer”) to select, on a bill payment portal provided by biller system 370, a payment method of using payment-messaging system 350 (e.g., Zelle), such as shown in FIGS. 4 and/or 5, and described above. As described above, part of consumer 310 selecting this payment method can involve consumer 310 providing the public identifier that consumer 310 has previously registered with payment-messaging system 350. The public identifier (sender token) can be sent from consumer device 320 to biller system 370 (which can be controlled by biller 380 or a third-party service provider, such as a BSP).

Next, at activity 602, biller system 370 can request additional information about the sender token by sending a request to biller financial institution 360. At activity 603, biller financial institution 360 can send the request to payment-messaging system 350. This request for additional information about the token can ask payment-messaging system 350 to validate if the sender token can be used to authorize the payment using payment-messaging system 350, which can involve, in a number of embodiments, performing a risk determination and returning a risk metric (e.g., risk score). In many embodiments, the request for additional information can include information about consumer 310 provided by biller system 370, based on the user profile of consumer 310 that is logged into biller system 370. For example, the information from the user profile can include name information (e.g., first name, middle name, last name, and/or full name) of the consumer, address information (e.g., residential street address, city, state, postal code), email address information, phone number information, duration of the consumer account with the biller, profile change event history, IP (internet protocol) address and/or reputation information from which the login to biller system 370 occurred, browser information, and/or other suitable information about consumer 310.

Next, at activity 604, payment-messaging system 350 can determine whether the sender token can be used to authorize a payment by validating the sender token, which can include checking if the sender token is registered and active in directory 353 (FIG. 3) of payment-messaging system 350, determining how long the sender token has been registered, and/or determining whether the sender token is a known bad token.

In many embodiments, when the sender token is a phone number, payment-messaging system 350 can request information associated with the phone number from the mobile network operator (MNO) at which the phone number is registered, or use such information if it has been already obtained. For example, the mobile network operator can provide name information (e.g., first name, middle name, last name, and/or full name) of the consumer, address information (e.g., residential street address, city, state, postal code), email address information; phone status information, device information (e.g., obtained based on an mSDK (mobile software development kit)) if consumer 310 (FIG. 3) is using a mobile device, and/or other suitable information.

In some embodiments, the phone status information can include tenure of the relationship with the MNO, name of the MNO, porting events, phone number change events, network status (e.g., whether the account associated with the phone number is active or deactivated), SIM (subscriber identity module) card swap events, SIM operator name, SIM serial number, IMEI (International Mobile Equipment Identity) information, device change events, account type, account role (e.g., owner, member, etc.), user type (e.g., personal, business government, wholesale, employee, unknown), phone number change events, velocity, porting velocity, porting status, line type (e.g., mobile, landline, fixed VoIP (voice over internet protocol), non-fixed VoIP, other), and/or other suitable information. In many embodiments, a phone identity verification service, e.g., Prove API, can be used to provide some or all of the MNO information and/or phone information. In several embodiments, payment-messaging system 350 can compare the user profile information received from biller system 370 and the information received from the MNO to do name matching, address matching, and/or email address matching to determine if the information for consumer 310 matches.

If the sender token is an email address, information about the user associated with the email address can be obtained, such as by using a third-party email identity verification service, such as Emailage. For example, the first name and last name of the user associated with the email address can be obtained. This information can be compared with the user profile information obtained from biller system 370.

In a number of embodiments, payment-messaging system 350 can use the information to perform a risk analysis. In many embodiments, one or more of these factors can be used by a risk engine to determine a risk metric (e.g., risk score). For example, contextual information can be received from biller 380, biller system 370, biller financial institution 360, one or more third parties (e.g., resellers), etc. The contextual information can include customer contextual information about the customer relationship between consumer 310 can biller 380 (e.g., duration with biller, profile change history, address, other data about the customer), location contextual information about consumer 310 (e.g., city, state, country, geo location, etc.), device contextual information (e.g., mobile carrier name, SIM operatory, SIM serial number/IMEI, browser information), network contextual information (e.g., IP address/reputation), and/or other suitable information, and/or other suitable contextual information.

In some embodiments, the risk engine can respond with one of three status responses (e.g., Green, Yellow, or Red) on whether a payment can be authorized for the sender token (i.e., passive authentication). For the Green status, the sender token was successfully authenticated. For the Yellow status, the sender token requires additional active authentication, such as a step-up authentication through one-time passcode, an identity authentication service (e.g., OpenID Connect (OIDC), XID, OAuth, etc.), or another authentication method (e.g., push notification, etc.). In some embodiments, the step-up authentication method to be used can be selected by biller 380, biller system 370, biller financial institution 360, and/or consumer financial institution 340. For the Red status, consumer 310 is declined, and the sender token may not be used for the payment. In many embodiments, other metrics can be used, such as numeric, alphabetic, alphanumeric, scores, reason codes, attributes, rankings, and/or other suitable metrics. In several embodiments, activity 604 can include payment-messaging system 350 returning this information (e.g., whether the token can be used and/or the risk metric) to biller system 370, which in many embodiments can be returned through biller financial institution 360. In some embodiments, payment-messaging system 350 can include the tokenized identifier associated with the sender token from directory 353 (FIG. 3).

Next, at activity 605, biller 380 and/or biller system 370 can determine whether to accept the liability for the payment. This determination of whether to accept liability can be based on the information returned to biller system 370. For example, if the sender token cannot be used to authorize the payment (e.g., Red status), then the payment does not proceed. If the sender token can potentially be used to authorize the payment (e.g., Yellow or Green status), then, in many embodiments, biller system 370 can determine whether to accept liability for the payment, based on the risk metric (e.g., risk score) provided by payment-messaging system 350. In many embodiments, with Green status, biller system 370 can determine to accept liability, and for Yellow status, biller system can perform additional authentication, such as the step-up authentication. For example, in some embodiments, biller system 370 can send a one-time passcode to the sender token, after which, if consumer 310 is able to access the system associated with the sender token, consumer 310 can enter the one-time passcode in the bill payment portal to provide authentication.

If the biller 380 and/or biller system 370 ultimately decides to accept liability, then method 600 proceed to activity 606, at which consumer 310 can submit the payment. In many embodiments, the bill payment portal can enable a button that allow the user to submit the payment request. Next, at activity 607, an Authorization for Payment (AFP) message can be generated by biller system 370, and the AFP message which can be sent to biller financial institution 360. In many embodiments, the AFP message can include a flag or other indicator that biller 380 is accepting liability of the payment. The AFP can be treated as a preapproved Payment Request, which can be a message that contains a request for payment funds and an approval for consumer financial institution 340 to fulfil the request upon receipt.

In a number of embodiments, unlike other “credit push” transactions that can be initiated by consumer 310, such as a payment request initiated by consumer 310 at consumer financial institution 340 to send a payment from consumer 310 to a payee (e.g., biller 380)), in many embodiments, the payment request can appear to consumer 310 to be a “debit pull” transaction, biller system 370 of biller 380 is requesting that funds be pulled from consumer 310 and provided to biller 380. In several embodiments, this “debit pull” approach can conceal a payment request from consumer 310, such that after consumer 310 initiates, at biller system 370 of biller 380, a payment request that funds be pulled from consumer 310 and provided to biller 380, consumer 310 does not receive a request from consumer financial institution 340 to verify whether or not consumer 310 in fact initiated the payment request at biller system 370. In other words, once initiated by consumer 310 at biller system 370, the payment can be automated without consumer 310 doing anything further. In many embodiments, the new AFP message can provide this functionality. In some embodiments, whether or not the payment request is concealed from consumer 310 can depend on biller 380, biller financial institution 360, and/or consumer financial institution 340.

At activity 608, the AFP message can be sent from biller financial institution 360 to payment-messaging system 350. In some embodiments, payment-messaging system 350 can determine whether the requestor (biller 380, biller system 370, and/or biller financial institution 360) sending the AFP message is registered and authorized to send the AFP message using the direct electronic bill payment with real-time funds availability techniques described herein. If so, next, at activity 609, payment-messaging system 350 can send the AFP message to consumer financial institution 340. In many embodiments, the tokenized identifier associated with the sender token from directory 353 (FIG. 3) can be used to know which consumer financial institution (e.g., 340) is associated with consumer 310 based on the sender token. The tokenized identifier can be used by consumer financial institution 340 to identify consumer account 343 (FIG. 3), based on a mapping from the tokenized identifier to an account identifier of consumer account 343 that is stored within consumer financial institution 340.

Next, at activity 610, consumer financial institution 340 can debit consumer account 343 (FIG. 3) (e.g., pull funds using a memo post) and can send a payment message to payment-messaging system 350. In many embodiments, the payment message can include an irrevocable promise to pay from consumer financial institution 340 to biller financial institution 360. In many embodiments, the payment message can be a credit push that is concealed from consumer 310. At activity 611, payment-messaging system 350 can send the payment message to biller financial institution 360. At activity 612, biller financial institution 360 can credit biller account 363 (FIG. 3) with the funds. In some embodiments, at activity 612, biller financial institution can send a change payment status message to payment-messaging system 350, indicating that the payment has been credited to biller account 363 (FIG. 3), which in some embodiments can be processed using a new service and notification set for change payment status. At activity 613, biller financial institution 360 can send a remittance message to biller system 370. At activity 614, upon receipt of the remittance message, biller system 370 can generate a confirmation number and post the payment to consumer billing account 373 (FIG. 3). In many embodiments, the confirmation number can be sent from biller system 370 to consumer device 320 to show to consumer 310 through the bill payment portal. In the same or other embodiments, biller system 370 can send the confirmation number in a confirmation message to biller financial institution 360. Payment-messaging system 350 can pass the payment status change message to consumer financial institution 340, which can then send the confirmation message and/or confirmation number to consumer device 320 to display to consumer 310. In several embodiments, the payment can be completed in real-time from the time that consumer 310 submitted payment in activity 606 until payment is posted in activity 614. In many embodiments, sending of actual funds from consumer financial institution 340 to biller financial institution 360 can occur later through settlement network 390, such as through daily and/or nightly batch ACH settlement. In other embodiments, real-time settlement can occur.

The method of FIG. 6 involves a biller liability model, in which the biller determines whether to assume liability for the payment. An advantage of this approach is reduced customer friction in the ‘make payment’ process, as consumer financial institution 340 does not reach out to consumer 310 to verification that the consumer is actually requesting the payment. A disadvantage for biller 380 is risk and financial liability for unauthorized payments. Billers can mitigate this risk by using the risk metric when determining whether to accept and when initiating an AFP. In some embodiments biller financial institution 360 can assume liability for the payment. In other embodiments a third-party service provider (e.g., a BSP providing biller system 370) can assume the liability. In several embodiments, biller 380 and biller financial institution 360 can both assume the liability (e.g., 50/50 or 75/25, etc.). In many embodiments, biller 380 and the third-party service provider can both assume the liability (e.g., 50/50 or 75/25, etc.). In at least one embodiment, biller 380, biller financial institution 360, and the third-party service provider (e.g., a BSP providing biller system 370) can all assume the liability (e.g., 33/33/33 or Oct. 30, 1960, etc.).

Another method involves a bank authentication model, in which consumer financial institution 340 assumes liability for the payment. In this model, the consumer financial institution 340 authenticates consumer 310. This model introduces more friction in the ‘make payment’ process than the biller liability model shown in FIG. 6. In some embodiments, consumer financial institution 340 assumes the liability unless biller 380 (or biller financial institution 360, or third-party service provider (e.g., a BSP providing biller system 370)) affirmatively opts to assume the liability. In many embodiments, consumer financial institution 340 can authorize consumer 310 using conventional mobile app authentication methods, such as passcode, push notification, biometrics, etc. In several embodiments, there can be two separate authentications: (1) an initial authentication of consumer 310, and (2) an authentication of each transaction involving consumer 310. In some embodiments, the assumed liability can be a risk of fraud. In other embodiments, the assumed liability can be a risk of credit loss. In at least one embodiment, the assumed liability can be a risk of both fraud and credit loss. In some embodiments, the bank authentication model can be used, but based on precedence, such as previous successful transactions, the friction can be removed.

In some embodiments, the biller liability and bank authentication models can be combined, such that both consumer financial institution 340 and biller 380 (or biller financial institution 360 or third-party service provider (e.g., a BSP providing biller system 370)) share the assumed liability (e.g., 50/50 or 25/75, etc.). In some embodiments the liability sharing, such as acceptance of partial liability, can be on a transaction-by-transaction basis. For example, the parties can opt to accept or decline liability for certain transaction types and/or transaction amounts. In other embodiments, for certain types of transactions, one of the parties alone can assume the liability for that transaction. In some embodiments, the parties can share liability on a single transaction.

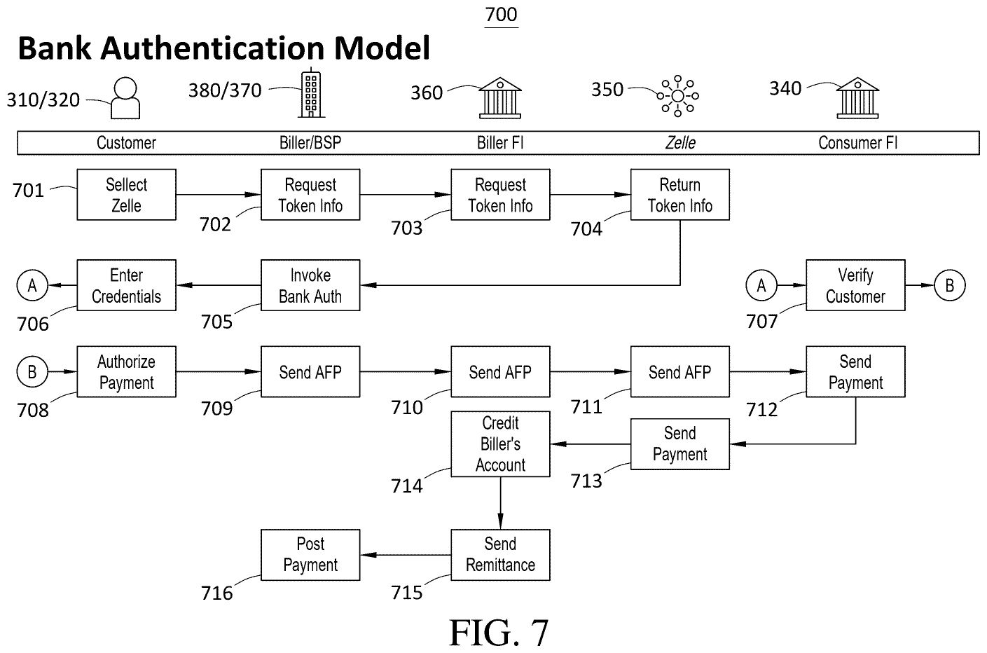

Turning ahead in the drawings, FIG. 7 illustrates a flow chart for a method 700 of facilitating direct electronic bill payment with real-time funds availability in a bank authentication model, according to an embodiment. Method 700 is merely exemplary and is not limited to the embodiments presented herein. Method 700 can be employed in many different embodiments or examples not specifically depicted or described herein. In some embodiments, the procedures, the processes, and/or the activities of method 700 can be performed in the order presented. In other embodiments, the procedures, the processes, and/or the activities of method 700 can be performed in any suitable order. In still other embodiments, one or more of the procedures, the processes, and/or the activities of method 700 can be combined or skipped. Method 700 can be similar to method 600 (FIG. 6), and various activities of method 700 can be similar or identical to various activities of method 600 (FIG. 6).

In many embodiments, system 300 (FIG. 3) can be suitable to perform method 700 and/or one or more of the activities of method 700, such as activities 701-716. In these or other embodiments, one or more of the activities of method 700 can be implemented as one or more computing instructions configured to run at one or more processors and configured to be stored at one or more non-transitory computer readable media. Such non-transitory computer readable media can be part of system 300. The processor(s) can be similar or identical to the processor(s) described above with respect to computer system 100 (FIG. 1). In some embodiments, method 700 and other activities in method 700 can include using a distributed network including distributed memory architecture to perform the associated activity. This distributed architecture can reduce the impact on the network and system resources to reduce congestion in bottlenecks while still allowing data to be accessible from a central location.

Referring to FIG. 7, method 700 can begin with an activity 701 of consumer 310 using consumer device 320 to select, on a bill payment portal provided by biller system 370, a payment method of using payment-messaging system 350 (e.g., Zelle), such as shown in FIGS. 4 and/or 5, and described above. Activity 701 can be similar or identical to activity 601 (FIG. 6). As described above, part of consumer 310 select this payment method can involve consumer 310 providing the public identifier that consumer 310 has previously registered with payment-messaging system 350. The public identifier (sender token) can be sent from consumer device 320 to biller system 370.

Next, at activity 702, biller system 370 can request additional information about the sender token by sending a request to biller financial institution 360. Activity 702 can be similar or identical to activity 602 (FIG. 6). At activity 703, biller financial institution 360 can send the request to payment-messaging system 350. Activity 703 can be similar or identical to activity 603 (FIG. 6).

Next, at activity 704, payment-messaging system 350 can determine whether the sender token can be used to authorize a payment by validating the sender token, and returning this information (e.g., whether the token can be used and/or the risk metric) to biller system 370, which in many embodiments can be returned through biller financial institution 360. Activity 704 can be similar or identical to activity 604 (FIG. 6).

Next, at activity 705, biller 380 and/or biller system 370 can invoke a bank authentication from consumer financial institution 340. In some embodiments, the bank authentication can be invoked when consumer financial institution 340 is responsible for assuming liability. In other embodiments, bank authentication can be invoked at activity 705 when biller 380 and/or biller system 370 decide to not accept liability, such as at activity 605 (FIG. 6), such as because the risk status is Red, and/or the risk score is too low. In effect, such a determination by biller 380 and/or biller system 370 to not assume liability can cause the biller liability model of method 600 (FIG. 6) to because the bank authentication model of method 700 of FIG. 7. By invoking bank authentication, biller 380 and/or biller system 370 indicates to consumer 310 and/or consumer financial institution 340 that it is not assuming responsibility for the payment.

In many embodiments, biller system 370 can send information to consumer device 320 to be displayed to consumer 310 regarding the bank authentication, such as displaying information about how consumer financial institution 340 will authenticate consumer 310 before the payment can be processed. In some embodiments, biller system 370 can redirect to consumer financial institution 340 to initiate authentication of consumer 310. In some embodiments, consumer financial institution 340 can request information from consumer 310, or can authenticate consumer 310, through a push app notification, text (e.g., SMS) message, email message, or other message to consumer 310. In many embodiments, consumer 310 enter a one-time passcode or other credentials using consumer device 320. In some embodiments, the bank authentication done by consumer financial institution 340 can be done outside the bill payment portal provided by biller system 370. In other embodiments, the bank authentication done by consumer financial institution 340 can be performed inside the bill payment portal provided by biller system 370 or through a redirection to consumer financial institution 340 handled within the bill payment portal.

In yet other embodiments, biller system 370 can invoke the bank authentication by calling an identity verification service, such as OpenID Connect (OIDC), XID, OAuth, etc. In some embodiments, the identity verification service can be provided by payment-messaging system 350. In other embodiments, the identity verification service can be provided by a third-party. For example, when the identity verification service is provided by payment-messaging system 350, biller system 370 can redirect to payment-messaging system 350, such as through the XID URL (uniform resource locator). In many embodiments, payment-messaging system 350 can redirect to the OIDC URL, which can allow consumer 310 to login to consumer financial institution 340, perform any step-up authentication specified by consumer financial institution 340, show payment details to consumer 310, and ask for payment authorization and/or approval. After approved, consumer financial institution 340 can return an authorization code to payment-messaging system 350, which can then return the authorization code to biller system 370. In some embodiments, biller 380 can request an access token from consumer financial institution 340, such as by communicating with consumer financial institution 340 through payment-messaging system 350 using XID, and can receive this access token if approved by consumer financial institution 340. In such embodiments using an identity verification service, flow of method 700 can proceed to activity 709, described below.

When not using an identity verification service, consumer 310 can enter credentials for the bank authentication at activity 706, such as consumer login information for consumer financial institution 340, one-time passcode, or other authorization. This credential information can be sent to consumer financial institution 340 from consumer device 320 and/or biller system 370. At activity 707, consumer financial institution 340 can verify the credentials of consumer 310 to complete the bank authentication.

After consumer financial institution 340 has completed the bank authentication, biller system 370 can display the submit payment button to consumer 310 on the bill payment portal, which can allow consumer to authorize the payment. At activity 708, consumer 310 can authorize the payment by selecting the payment button. In yet other embodiments, biller system 370 can enable the button to allow consumer 310 to submit payment before the bank authentication is complete, but can include information or instructions that consumer financial institution 340 will do a bank authentication after consumer 310 selects the button to authorize the payment. Activity 708 can be similar to activity 606 (FIG. 6).

Next, at activity 709, biller system can generate and send an AFP message to biller financial institution 360. Activity 709 can be similar to activity 607 (FIG. 6). In many embodiments, the AFP message can include a flag or other indicator that biller 380 is not accepting liability of the payment, and if the bank authentication is already complete, can refer to the verification performed by consumer financial institution 340, such as by including an authorization code and/or access token provided by consumer financial institution 340.

Next, at activity 710, the AFP message can be sent from biller financial institution 360 to payment-messaging system 350. Activity 710 can be similar or identical to activity 608 (FIG. 6). In some embodiments, payment-messaging system 350 can determine whether the requestor (biller 380, biller system 370, and/or biller financial institution 360) sending the AFP message is registered and authorized to send the AFP message using the direct electronic bill payment with real-time funds availability techniques described herein. If so, next, at activity 711, payment-messaging system 350 can send the AFP message to consumer financial institution 340. Activity 711 can be similar or identical to activity 609 (FIG. 6).

Upon consumer financial institution 340 receiving the AFP message, consumer financial institution 340 can determine if the payment request has already been authorized by consumer financial institution 340 (e.g., by consumer financial institution 340 checking the authorization code or access token included in the AFP), or instead if bank authentication has yet to be performed. If bank authentication has not yet been performed, consumer financial institution 340 can perform bank authentication, such as by sending a message (e.g., a call-to-action (CTA) notification, such as a push app notification, text (SMS) message, email message, or other suitable message) to consumer 310 to authenticate consumer 310 and/or obtain authorization from consumer 310.

After consumer financial institution 340 determines that bank authorization was successfully completed, consumer financial institution 340 can debit consumer account 343 (FIG. 3) (e.g., pull funds using a memo post) and can send a payment message to payment-messaging system 350 at activity 712. Activity 712 can be similar to activity 610 (FIG. 6). At activity 713, payment-messaging system 350 can send the payment message to biller financial institution 360. Activity 713 can be similar or identical to activity 611 (FIG. 6). At activity 714, biller financial institution 360 can credit biller account 363 (FIG. 3) with the funds. Activity 714 can be similar or identical to activity 612 (FIG. 6). At activity 715, biller financial institution 360 can send a remittance message to biller system 370. Activity 715 can be similar or identical to activity 613 (FIG. 6). At activity 716, upon receipt of the remittance message, biller system 370 can generate a confirmation number and post the payment to consumer billing account 373 (FIG. 3). Activity 716 can be similar or identical to activity 614 (FIG. 6). In many embodiments, the confirmation number can be sent from biller system 370 to consumer device 320 to show to consumer 310 while consumer 310 through the bill payment portal. In the same or other embodiments, biller system 370 can send the confirmation number in a confirmation message to biller financial institution 360. After receiving the confirmation message, biller financial institution 360 can send a change payment status message to payment-messaging system 350, indicating that the payment has been credited to biller account 363 (FIG. 3). Payment-messaging system 350 can pass the payment status change message to consumer financial institution 340, which can then send the confirmation message and/or confirmation number to consumer device 320 to display to consumer 310. In several embodiments, the payment can be completed in real-time from the time consumer 310 submitted payment in activity 706 until payment is posted in activity 714. In many embodiments, sending of actual funds from consumer financial institution 340 to biller financial institution 360 can occur later through settlement network 390, such as through daily and/or nightly batch ACH settlement. In other embodiments, real-time settlement can occur.

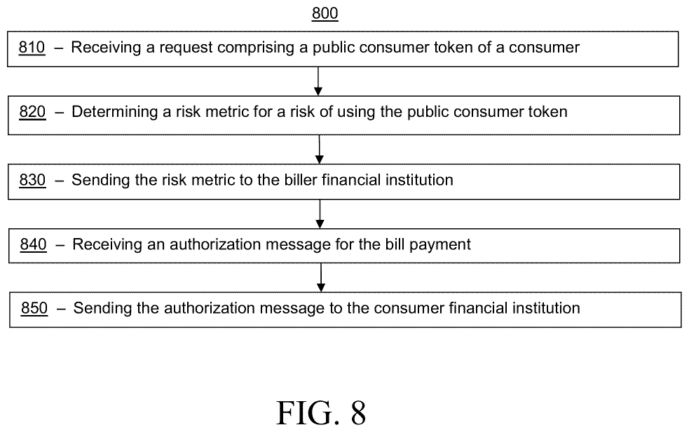

Turning ahead in the drawings, FIG. 8 illustrates a flow chart for a method 800 of facilitating direct electronic bill payment with real-time funds availability, according to an embodiment. Method 800 is merely exemplary and is not limited to the embodiments presented herein. Method 800 can be employed in many different embodiments or examples not specifically depicted or described herein. In some embodiments, the procedures, the processes, and/or the activities of method 800 can be performed in the order presented. In other embodiments, the procedures, the processes, and/or the activities of method 800 can be performed in any suitable order. In still other embodiments, one or more of the procedures, the processes, and/or the activities of method 800 can be combined or skipped. Method 800 can be similar or identical to method 600 (FIG. 6) and/or method 700 (FIG. 7). Various activities of method 800 can be similar or identical to various activities of method 600 (FIG. 6) and/or method 700 (FIG. 7).

In many embodiments, system 300 (FIG. 3) and/or payment-messaging system 350 (FIG. 3) can be suitable to perform method 800 and/or one or more of the activities of method 800. In these or other embodiments, one or more of the activities of method 800 can be implemented as one or more computing instructions configured to run at one or more processors and configured to be stored at one or more non-transitory computer readable media. Such non-transitory computer readable media can be part of system 300. The processor(s) can be similar or identical to the processor(s) described above with respect to computer system 100 (FIG. 1). In some embodiments, method 800 and other activities in method 800 can include using a distributed network including distributed memory architecture to perform the associated activity. This distributed architecture can reduce the impact on the network and system resources to reduce congestion in bottlenecks while still allowing data to be accessible from a central location.

Referring to FIG. 8, method 800 can include an activity 810 of receiving, at a payment-messaging system from a biller financial institution, a request comprising a public consumer token of a consumer. The biller financial institution can be similar or identical to biller financial institution 360 (FIG. 3). The consumer can be similar or identical to consumer 310 (FIG. 3) and/or consumer device 320 (FIG. 3). The request can be similar or identical to the request sent from biller financial institution 360 (FIG. 3) to payment-messaging system 350 in activities 603 (FIGS. 6) and/or 703 (FIG. 7). The payment-messaging system can be similar or identical to payment-messaging system 350 (FIG. 3). The public consumer token can be similar or identical to the public identifier and/or sender token described above. In some embodiments, the public consumer token can be a phone number, a Zelle tag, or email address of the consumer.

In a number of embodiments, the consumer provided the public consumer token to a biller system of a biller for a bill payment by the consumer to the biller, similar or identical to activities 601 (FIG. 6) or 701 (FIG. 7). The biller system can be similar or identical to biller system 370 (FIG. 3). The biller can be similar or identical to biller 380 (FIG. 3). In several embodiments, the biller system provided the public consumer token to the biller financial institution, similar or identical to activities 602 (FIG. 6) or 702 (FIG. 7). In a number of embodiments, the biller financial institution maintains a biller account of the biller. The biller account can be similar or identical to biller account 363 (FIG. 3). In some embodiments, the consumer requested the bill payment without providing the biller with account information of a consumer account of the consumer maintained at a consumer financial institution. The consumer account can be similar or identical to consumer account 343 (FIG. 3). The consumer financial institution can be similar or identical to consumer financial institution 340 (FIG. 3).

In a number of embodiments, method 800 also can include an activity 820 of determining a risk metric representing a risk of using the public consumer token for the bill payment. In several embodiments, the risk metric can be calculated based in part on information about the consumer received from the biller, information about the consumer received from the MNO associated with the phone number of the biller, information about the consumer received about the email address associated with the consumer, information about a mobile device used by the consumer, and/or other suitable information.

In several embodiments, method 800 additionally can include an activity 830 of sending the risk metric from the payment-messaging system to the biller financial institution. In some embodiments, the biller financial institution can send the risk metric to the biller system to allow the biller to determine whether to assume liability for the bill payment. Activities 820 and/or 830 can be similar or identical to activities 604 (FIGS. 6) and/or 704 (FIG. 7).

In a number of embodiments, method 800 further can include an activity 840 of receiving, at the payment-messaging system from the biller financial institution, an authorization message for the bill payment. The authorization message can be similar or identical to the AFP message sent from biller financial institution 360 to payment-messaging system 350 in activities 608 (FIGS. 6) and/or 710 (FIG. 7). In a number of embodiments, the authorization message was provided to the biller financial institution by the biller system, similar or identical to activities 607 (FIGS. 6) and/or 709 (FIG. 7).

In some embodiments, the authorization message was provided by the biller system after the biller assumed liability for the bill payment, similar or identical to activity 605 (FIG. 6) in the biller liability model of method 600 (FIG. 6). In some such embodiments, the biller assumed liability for the bill payment based on the risk metric provided by the payment-messaging system, and/or the biller assumed liability for the bill payment after performing a step-up authentication of the consumer.

In other embodiments, the authorization message was provided by the biller system after the consumer financial institution assumed liability for the bill payment, similar or identical to activities 705-707 (FIG. 7) in the bank authentication model of method 700 (FIG. 7). In some such cases, the biller did not assume liability for the payment, and/or the consumer financial institution assumed liability for the bill payment after performing an authentication of the consumer.

In several embodiments, method 800 additionally can include an activity 850 of sending the authorization message for the bill payment to a consumer financial institution, to cause the consumer financial institution to send a real-time payment message through the payment-messaging system to the biller financial institution to make funds available in real-time in the biller account for the bill payment. Activity 850 can be similar or identical to activities 609 (FIGS. 6) and/or 711 (FIG. 7). The real-time payment message can be similar or identical to the message sent in activities 609-610 (FIGS. 6) and/or 712-13 (FIG. 7). The making of funds available in real-time in the biller account can be similar or identical to activities 612-614 (FIGS. 6) and/or 714-716 (FIG. 7).

In some embodiments, the real-time payment message includes an irrevocable promise to pay a payment amount for the bill payment from the consumer account of the consumer maintained at the consumer financial institution to the biller account. In various embodiments, settlement of the bill payment between the consumer financial institution and the biller financial institution can occur in a batch ACH or other suitable later settlement methods after the funds are made available in real-time in the biller account, or can be settled in real-time through TCH (The Clearing House) RTP (Real-Time Payments) for the FedNow service offered by the federal reserve banks or other suitable real-time settlement rails.

Returning to FIG. 3, in several embodiments, communication system 351 can at least partially perform activities 603-604 and/or 608-611 (FIG. 6), activities 703-704 and/or 710-713 (FIG. 7), and/or activities 810, 830, 840, and/or 850 (FIG. 8).

In several embodiments, risk engine 352 can at least partially perform activity 604 (FIG. 6), activity 704 (FIG. 7), and/or activity 820 (FIG. 8).

In many embodiments, the techniques described herein can provide a practical application and several technological improvements. In some embodiments, the techniques described herein can provide for direct electronic bill payment with real-time funds availability. These techniques described herein can provide a significant improvement over conventional approaches of in which consumers (e.g., 310) provide sensitive PII (personally identifiable information), such as debit or credit card numbers, bank account numbers, etc., to the biller for bill payment. Instead, a consumer can provide a public identifier, such as an email address or phone number to the biller to make secure bill payments.

In several embodiments, the techniques described herein can beneficially cause the funds to be automatically debited from the customer account (e.g., 343) and made available in real-time to the biller account (e.g., 363). These techniques can extend the credit push model within the context of the bill payment portal by adding a debit pull model that leverages an existing payment request function. In several embodiments, the payment request in the credit push process from the consumer financial institution (e.g., 340) to the biller financial institution (e.g., 360) can be concealed, such that after the consumer initiates a payment request from the biller's bill payment portal, the request, in many cases, is not subsequently presented to the consumer for authorization from the consumer financial institution.

In a number of embodiments, techniques described herein can advantageously use risk-based token authorization, such that consumer interaction can be minimized by not asking the consumer to authenticate after the consumer has entered the initiated the payment request. In several embodiments, the risk determination can use contextual information gathered about the consumer. In a number of embodiments, a graded/tiered authentication can be used depending on the risk level.

In many embodiments, the techniques described herein can be used continuously at a scale that cannot be handled using manual techniques. For example, the techniques can be applied to millions of transactions daily.

In a number of embodiments, personally identifiable information of consumers (e.g., consumer 310 (FIG. 3)) can be protected by not including such information in messages exchanged between the financial institutions (e.g., consumer financial institution 340, biller financial institution 360 (FIG. 3)), the payment-messaging system (e.g., 350 (FIG. 3), and/or the settlement network (e.g., settlement network 390 (FIG. 3)), which can reduce the risk of fraud if messages are intercepted or otherwise compromised.

In many embodiments, the techniques described herein can beneficially eliminate insufficient funds (NSF) messages and resulting chargebacks to the billers that exist in many conventional bill payment approaches, as the consumer financial institution (e.g., 340) will not send the payment message to the biller financial institution (e.g., 360) unless the consumer account (e.g., 343) has sufficient funds.

In a number of embodiments, the techniques described herein can solve a technical problem that arises only within the realm of computer networks, as online payment does not exist outside the realm of computer networks. Moreover, the techniques described herein can solve a technical problem that cannot be solved outside the context of computer networks. Specifically, the techniques described herein cannot be used outside the context of computer networks, in view of a lack of ability to securely send payment messages in real-time.

Various embodiments can include a system including one or more processors and one or more non-transitory computer-readable media storing computing instructions that, when executed on the one or more processors, perform certain acts. The acts can include receiving, at a payment-messaging system from a biller financial institution, a request comprising a public consumer token of a consumer. The consumer provided the public consumer token to a biller system of a biller for a bill payment by the consumer to the biller. The biller system provided the public consumer token to the biller financial institution. The biller financial institution maintains a biller account of the biller. The acts also can include determining a risk metric representing a risk of using the public consumer token for the bill payment. The acts additionally can include sending the risk metric from the payment-messaging system to the biller financial institution. The biller financial institution sends the risk metric to the biller system to allow the biller to determine whether to assume liability for the bill payment. The acts further can include receiving, at the payment-messaging system from the biller financial institution, an authorization message for the bill payment. The authorization message was provided to the biller financial institution by the biller system. The acts additionally can include sending the authorization message for the bill payment to a consumer financial institution, to cause the consumer financial institution to send a real-time payment message through the payment-messaging system to the biller financial institution to make funds available in real-time in the biller account for the bill payment.

A number of embodiments can include a method being implemented via execution of computing instructions configured to run at one or more processors. The method can include receiving, at a payment-messaging system from a biller financial institution, a request comprising a public consumer token of a consumer. The consumer provided the public consumer token to a biller system of a biller for a bill payment by the consumer to the biller. The biller system provided the public consumer token to the biller financial institution. The biller financial institution maintains a biller account of the biller. The method also can include determining a risk metric representing a risk of using the public consumer token for the bill payment. The method additionally can include sending the risk metric from the payment-messaging system to the biller financial institution. The biller financial institution sends the risk metric to the biller system to allow the biller to determine whether to assume liability for the bill payment. The method further can include receiving, at the payment-messaging system from the biller financial institution, an authorization message for the bill payment. The authorization message was provided to the biller financial institution by the biller system. The method additionally can include sending the authorization message for the bill payment to a consumer financial institution, to cause the consumer financial institution to send a real-time payment message through the payment-messaging system to the biller financial institution to make funds available in real-time in the biller account for the bill payment.

Additional embodiments include a payment-messaging computing system comprising one or more processors and one or more non-transitory computer-readable media storing computing instructions that, when executed on the one or more processors, cause the one or more processors to perform certain operations. The operations can include receiving, at the payment-messaging computing system from a biller financial institution, a request for information about a public consumer token of a consumer. The request for information comprises the public consumer token of the consumer. The public consumer token is one of a phone number, a Zelle tag, or an email address of the consumer. The request for information is received at the payment-messaging computing system after the consumer provided the public consumer token to a biller computer of a biller for a bill payment by the consumer to the biller and the biller computer provided the public consumer token to the biller financial institution. The biller financial institution maintains a biller account of the biller. The operations also can include determining that the public consumer token of the consumer is registered and active in a directory of the payment-messaging computing system. The operations additionally can include determining a risk metric representing a risk of using the public consumer token for the bill payment. Determining the risk metric comprises obtaining consumer information comprising first consumer information received from the biller and second consumer information received from a mobile network operator associated with a mobile phone of the consumer. The directory provides a centralized repository for mapping tokenized identifiers to consumer account information for a plurality of consumers at a network of a plurality of financial institutions registered with payment-messaging computing system. The public consumer token of the consumer was added to the directory upon the consumer registering for the payment-messaging computing system through a consumer financial institution. The operations further can include sending the risk metric from the payment-messaging computing system to the biller financial institution to cause the biller financial institution to send the risk metric to the biller computer to allow the biller to determine whether to assume liability for the bill payment or instead request the consumer financial institution assume liability and whether to perform a step-up authentication, based on the risk metric. The operations additionally can include receiving, at the payment-messaging computing system from the biller financial institution, an authorization message for the bill payment after the authorization message was provided to the biller financial institution by the biller computer. The operations can include sending the authorization message for the bill payment to the consumer financial institution, to cause the consumer financial institution to send a real-time payment message through the payment-messaging computing system to the biller financial institution to make funds available in real-time in the biller account for the bill payment.

Additional embodiments include a computer-implemented method executed at one or more processors of a payment-messaging computing system. The method can include receiving, at the payment-messaging computing system from a biller financial institution, a request for information about a public consumer token of a consumer. The request for information comprises the public consumer token of the consumer. The public consumer token is one of a phone number, a Zelle tag, or an email address of the consumer. The request for information is received at the payment-messaging computing system after the consumer provided the public consumer token to a biller computer of a biller for a bill payment by the consumer to the biller and the biller computer provided the public consumer token to the biller financial institution. The biller financial institution maintains a biller account of the biller. The method also can include determining that the public consumer token of the consumer is registered and active in a directory of the payment-messaging computing system. The method additionally can include determining a risk metric representing a risk of using the public consumer token for the bill payment. Determining the risk metric comprises obtaining consumer information comprising first consumer information received from the biller and second consumer information received from a mobile network operator associated with a mobile phone of the consumer. The directory provides a centralized repository for mapping tokenized identifiers to consumer account information for a plurality of consumers at a network of a plurality of financial institutions registered with payment-messaging computing system. The public consumer token of the consumer was added to the directory upon the consumer registering for the payment-messaging computing system through a consumer financial institution. The method further can include sending the risk metric from the payment-messaging computing system to the biller financial institution to cause the biller financial institution to send the risk metric to the biller computer to allow the biller to determine whether to assume liability for the bill payment or instead request the consumer financial institution assume liability and whether to perform a step-up authentication, based on the risk metric. The method additionally can include receiving, at the payment-messaging computing system from the biller financial institution, an authorization message for the bill payment after the authorization message was provided to the biller financial institution by the biller computer. The method can include sending the authorization message for the bill payment to the consumer financial institution, to cause the consumer financial institution to send a real-time payment message through the payment-messaging computing system to the biller financial institution to make funds available in real-time in the biller account for the bill payment.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although direct electronic bill payment with real-time funds availability has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-8 may be modified, and that the foregoing discussion of certain of these embodiments does not necessarily represent a complete description of all possible embodiments. For example, one or more of the procedures, processes, or activities of FIGS. 6-8 may include different procedures, processes, and/or activities and be performed by many different modules, in many different orders, and/or one or more of the procedures, processes, or activities of FIGS. 6-8 may include one or more of the procedures, processes, or activities of another different one of FIGS. 6-8. As another example, the systems or component systems thereof within system 300 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A payment-messaging computing system comprising one or more processors and one or more non-transitory computer-readable media storing computing instructions that, when executed on the one or more processors, cause the one or more processors to perform operations comprising:
receiving, at the payment-messaging computing system from a biller financial institution, a request for information about a public consumer token of a consumer, wherein the request for information comprises the public consumer token of the consumer, wherein the public consumer token is one of a phone number, a Zelle tag, or an email address of the consumer, wherein the request for information is received at the payment-messaging computing system after the consumer provided the public consumer token to a biller computer of a biller for a bill payment by the consumer to the biller and the biller computer provided the public consumer token to the biller financial institution, and wherein the biller financial institution maintains a biller account of the biller;
determining that the public consumer token of the consumer is registered and active in a directory of the payment-messaging computing system;
determining a risk metric representing a risk of using the public consumer token for the bill payment, wherein determining the risk metric comprises obtaining consumer information comprising first consumer information received from the biller and second consumer information received from a mobile network operator associated with a mobile phone of the consumer, wherein the directory provides a centralized repository for mapping tokenized identifiers to consumer account information for a plurality of consumers at a network of a plurality of financial institutions registered with payment-messaging computing system, and wherein the public consumer token of the consumer was added to the directory upon the consumer registering for the payment-messaging computing system through a consumer financial institution;
sending the risk metric from the payment-messaging computing system to the biller financial institution to cause the biller financial institution to send the risk metric to the biller computer to allow the biller to determine whether to assume liability for the bill payment or instead request the consumer financial institution assume liability and whether to perform a step-up authentication, based on the risk metric;
receiving, at the payment-messaging computing system from the biller financial institution, an authorization message for the bill payment after the authorization message was provided to the biller financial institution by the biller computer; and
sending the authorization message for the bill payment to the consumer financial institution, to cause the consumer financial institution to send a real-time payment message through the payment-messaging computing system to the biller financial institution to make funds available in real-time in the biller account for the bill payment.

2. The payment-messaging computing system of claim 1, wherein the real-time payment message comprises an irrevocable promise to pay a payment amount for the bill payment from a consumer account of the consumer maintained at the consumer financial institution to the biller account.

3. The payment-messaging computing system of claim 1, wherein:
the consumer requested the bill payment without providing the biller with account information of a consumer account of the consumer maintained at the consumer financial institution.

4. The payment-messaging computing system of claim 1, wherein settlement of the bill payment between the consumer financial institution and the biller financial institution occurs in a batch ACH after the funds are made available in real-time in the biller account.

5. The payment-messaging computing system of claim 1, wherein the authorization message was provided by the biller computer after the biller assumed liability for the bill payment.

6. The payment-messaging computing system of claim 5, wherein the biller assumed liability for the bill payment based on the risk metric provided by the payment-messaging computing system.

7. The payment-messaging computing system of claim 5, wherein the biller assumed liability for the bill payment after performing the step-up authentication of the consumer.

8. The payment-messaging computing system of claim 1, wherein the authorization message was provided by the biller computer after the consumer financial institution assumed liability for the bill payment.

9. The payment-messaging computing system of claim 8, wherein:
the biller did not assume liability for the bill payment; and
the consumer financial institution assumed liability for the bill payment after performing an authentication of the consumer.

10. The payment-messaging computing system of claim 1, wherein the first consumer information received from the biller further comprises profile change event history for the consumer.

11. A computer-implemented method executed at one or more processors of a payment-messaging computing system, the computer-implemented method comprising:
receiving, at the payment-messaging computing system from a biller financial institution, a request for information about a public consumer token of a consumer, wherein the request for information comprises the public consumer token of the consumer, wherein the public consumer token is one of a phone number, a Zelle tag, or an email address of the consumer, wherein the request for information is received at the payment-messaging computing system after the consumer provided the public consumer token to a biller computer of a biller for a bill payment by the consumer to the biller and the biller computer provided the public consumer token to the biller financial institution, and wherein the biller financial institution maintains a biller account of the biller;
determining that the public consumer token of the consumer is registered and active in a directory of the payment-messaging computing system;
determining a risk metric representing a risk of using the public consumer token for the bill payment, wherein determining the risk metric comprises obtaining consumer information comprising first consumer information received from the biller and second consumer information received from a mobile network operator associated with a mobile phone of the consumer, wherein the directory provides a centralized repository for mapping tokenized identifiers to consumer account information for a plurality of consumers at a network of a plurality of financial institutions registered with payment-messaging computing system, and wherein the public consumer token of the consumer was added to the directory upon the consumer registering for the payment-messaging computing system through a consumer financial institution;
sending the risk metric from the payment-messaging computing system to the biller financial institution to cause the biller financial institution to send the risk metric to the biller computer to allow the biller to determine whether to assume liability for the bill payment or instead request the consumer financial institution assume liability and whether to perform a step-up authentication, based on the risk metric;
receiving, at the payment-messaging computing system from the biller financial institution, an authorization message for the bill payment after the authorization message was provided to the biller financial institution by the biller computer; and
sending the authorization message for the bill payment to the consumer financial institution, to cause the consumer financial institution to send a real-time payment message through the payment-messaging computing system to the biller financial institution to make funds available in real-time in the biller account for the bill payment.

12. The computer-implemented method of claim 11, wherein the real-time payment message comprises an irrevocable promise to pay a payment amount for the bill payment from a consumer account of the consumer maintained at the consumer financial institution to the biller account.

13. The computer-implemented method of claim 11, wherein:
the consumer requested the bill payment without providing the biller with account information of a consumer account of the consumer maintained at the consumer financial institution.

14. The computer-implemented method of claim 11, wherein settlement of the bill payment between the consumer financial institution and the biller financial institution occurs in a batch ACH after the funds are made available in real-time in the biller account.

15. The computer-implemented method of claim 11, wherein the authorization message was provided by the biller computer after the biller assumed liability for the bill payment.

16. The computer-implemented method of claim 15, wherein the biller assumed liability for the bill payment based on the risk metric provided by the payment-messaging computing system.

17. The computer-implemented method of claim 15, wherein the biller assumed liability for the bill payment after performing the step-up authentication of the consumer.

18. The computer-implemented method of claim 11, wherein the authorization message was provided by the biller computer after the consumer financial institution assumed liability for the bill payment.

19. The computer-implemented method of claim 18, wherein:
the biller did not assume liability for the bill payment; and
the consumer financial institution assumed liability for the bill payment after performing an authentication of the consumer.

20. The computer-implemented method of claim 11, wherein the first consumer information received from the biller further comprises profile change event history for the consumer.
